(19) United States
(12) Patent Application Publication
(10) Pub. No.: US 2016/0261759 A1
(43) Pub. Date: Sep. 8, 2016

(54) INFORMATION PROCESSING SYSTEM, INFORMATION PROCESSING METHOD AND INFORMATION PROCESSING APPARATUS

(71) Applicant: Masatoshi YANASE, Kanagawa (JP)

(72) Inventor: Masatoshi YANASE, Kanagawa (JP)

(73) Assignee: Ricoh Company, Limited, Tokyo (JP)

(21) Appl. No.: 15/045,422

(22) Filed: Feb. 17, 2016

(30) Foreign Application Priority Data
Feb. 18, 2015 (JP) 2015-029994
Feb. 16, 2016 (JP) 2016-027330

(51) Int. Cl. H04N 1/00; H04N 1/32

(52) U.S. Cl. CPC H04N 1/00204; H04N 1/00896; H04N 1/32496; H04N 2201/0094

(57) ABSTRACT

An information processing system includes a remote operation terminal and an information processing apparatus configured to be remotely operated by the remote operation terminal via a network. The remote operation terminal includes a first operation receiver configured to receive first operating information of a first user who operates the information processing apparatus, and a transmitter configured to transmit the first operating information indicative of an operation received by the first operation receiver to the information processing apparatus. The information processing apparatus includes a receiver configured to receive the first operating information transmitted from the transmitter, a second operation receiver configured to receive second operating information of a second user who operates the information processing apparatus, an execution determiner configured to determine, for each of combinations of the first user and operation processings and combinations of the second user and the operation processings, whether the operation processing corresponding to the first or second operating information can be executed, based on authority information indicative of execution permission of the operation processing of the corresponding combination, and an executor configured to execute the operation processing determined to have execution permission by the execution determiner.

### CROSS-REFERENCE TO RELATED APPLICATIONS

The present application claims priority to and incorporates by reference the entire contents of Japanese Patent Application No. 2015-029994 filed in Japan on Feb. 18, 2015 and Japanese Patent Application No. 2016-027330 filed in Japan on Feb. 16, 2016.

### BACKGROUND OF THE INVENTION

1. Field of the Invention

The present invention relates to an information processing system, an information processing apparatus, an information processing method, and a computer-readable storage medium.

2. Description of the Related Art

On an image processing apparatus such as a multi-function printer (MFP), a user may make inquiries to a support person for the reason of not understanding the operation method, for example. In such a case, known has been a remote support technology in which the user can receive support by remote operation, by performing from a terminal (such as a PC) of the support person side the remote operation on the MFP that the user is using.

Japanese Patent No. 4660856 discloses a remote control system that uses a client terminal and a remote control server that are connected via a communication network to perform various remote operations, remote monitoring, teaching, and others.

However, in the conventional remote support technology, there has been a problem in which, even when the support person performs an inappropriate operation while the support person is manipulating the operation screen of the MFP of the user side by remote operation, the operation is to be executed.

### SUMMARY OF THE INVENTION

It is an object of the present invention to at least partially solve the problems in the conventional technology.

According to an embodiment, there is provided an information processing system that includes a remote operation terminal and an information processing apparatus configured to be remotely operated by the remote operation terminal via a network. The remote operation terminal includes a first operation receiver configured to receive first operating information of a first user who operates the information processing apparatus, and a transmitter configured to transmit the first operating information indicative of an operation received by the first operation receiver to the information processing apparatus. The information processing apparatus includes a receiver configured to receive the first operating information transmitted from the transmitter, a second operation receiver configured to receive second operating information of a second user who operates the information processing apparatus, an execution determiner configured to determine, for each of combinations of the first user and a plurality of operation processings and combinations of the second user and the plurality of operation processings, whether the operation processing corresponding to the first operating information or the operation processing corresponding to the second operating information can be executed, based on authority information indicative of execution permission of the operation processing of the corresponding combination, and an executor configured to execute the operation processing determined to have execution permission by the execution determiner.

According to another embodiment, there is provided an image processing method that includes receiving first operating information of a first user who operates an information processing apparatus connected to a network; receiving second operating information of a second user who operates the information processing apparatus; determining, for each of combinations of the first user and a plurality of operation processings and combinations of the second user and the plurality of operation processings, whether the operation processing corresponding to the first operating information or the operation processing corresponding to the second operating information can be executed, based on authority information indicative of execution permission of the operation processing of the corresponding combination; and executing the operation processing determined to have execution permission at the determining.

According to still another embodiment, there is provided an information processing apparatus configured to be remotely operated by a remote operation terminal via a network. The information processing apparatus includes a receiver configured to receive first operating information of a first user who operates the information processing apparatus from the remote operation terminal; a second operation receiver configured to receive second operating information of a second user who operates the information processing apparatus; an execution determiner configured to determine, for each of combinations of the first user and a plurality of operation processings and combinations of the second user and the plurality of operation processings, whether the operation processing corresponding to the first operating information or the operation processing corresponding to the second operating information can be executed, based on authority information indicative of execution permission of the operation processing of the corresponding combination; and an executor configured to execute the operation processing determined to have execution permission by the execution determiner.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating the configuration of an image processing system according to an embodiment.

FIG. 2 is a block diagram illustrating a hardware configuration of a PC.

FIG. 3 is a block diagram illustrating a hardware configuration of an image processing apparatus.

FIG. 4 is a schematic diagram illustrating one example of a software configuration of the image processing apparatus.

FIG. 5 is a diagram illustrating an example of an operation panel of an MFP.

FIG. 6 is an explanatory diagram illustrating an example of a current status of the image processing apparatus in remote connection.

FIG. 7 is a functional block diagram illustrating an outline of the functions of the PC and the image processing apparatus.

FIG. 8 is a sequence diagram illustrating the operation of the image processing system when a support person depressed an energy-saving button in remote operation.

FIG. 9 is a flowchart illustrating in detail the processing that an execution determiner determines whether execution permission of operation is given.

FIG. 10 is a sequence diagram illustrating the operation performed by various units constituting the image processing apparatus when the support person depressed the energy-saving button in remote connection.

FIG. 11 is a diagram illustrating data structure of operating information and operator information.

FIG. 12 is an explanatory diagram illustrating an example of a message screen when a determination result is being non-executable.

### DETAILED DESCRIPTION OF THE PREFERRED EMBODIMENTS

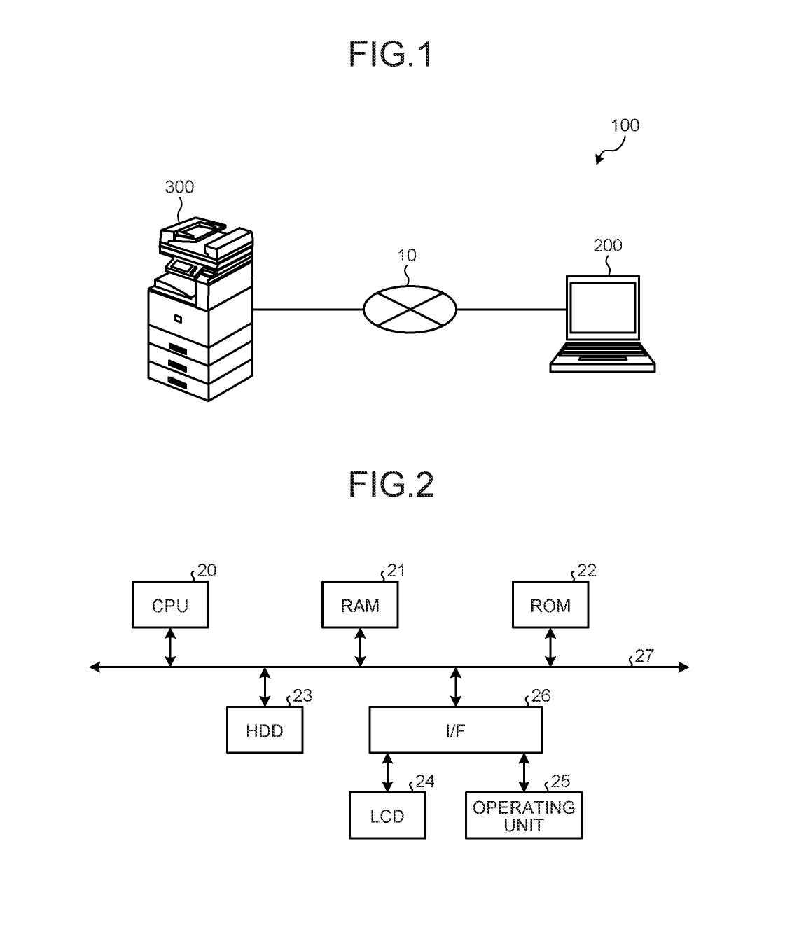

With reference to the accompanying drawings, the following describes an image processing system according to an exemplary embodiment in detail. FIG. 1 is a diagram illustrating the configuration of an image processing system 100 (an example of the information processing system) according to the embodiment. As illustrated in FIG. 1, the image processing system 100 includes a personal computer (PC: a remote operation terminal) 200 and an image processing apparatus 300 (an example of the information processing system) that are connected to each other via a network 10 such as the Internet, and is configured such that the image processing apparatus 300 can be remotely operated by the PC 200, for example. Here, the mode that the PC 200 and the image processing apparatus 300 are connected and the image processing apparatus 300 is remotely operated by the PC 200 is referred to as remote operation or remote connection.

The image processing apparatus 300 is an MFP provided with the function as a computer, and is configured such that a user (a second user) can operate the apparatus by using an operation screen such as a touch panel (an operation panel), for example. The operation panel may be replaced with an independent information processing terminal. The PC 200 receives an operating input that a support person (a first user) performs remote operation on the image processing apparatus 300 via the network 10. The user may inquire the support person by using a telephone or other communications. The operation screen operated by the user to operate the image processing apparatus 300 is configured to be sharable with the operation screen (a remote operation screen) of the PC 200 operated by the support person. In the following description, the image processing apparatus 300 is described as MFP 300 also, as appropriate.

The user is assumed to be a user who directly operates the image processing apparatus 300. The user makes inquiries to the support person such as when he or she does not understand how to operate the image processing apparatus 300. The support person is assumed to be a support person who receives inquiries by telephone from the user operating the image processing apparatus 300 and performs remote operation on the image processing apparatus 300 from the PC 200.

Specifically, the support person first manipulates the screen of the image processing apparatus 300 from the PC 200 to perform remote support for the user. For example, the support person specifies a job execution command, job setting, and others to the image processing apparatus 300 from the PC 200. It is adapted such that, when the support person happens to perform job execution such as printing erroneously, the user is prevented from being charged therefor.

FIG. 2 is a block diagram illustrating the hardware configuration of the PC 200. As illustrated in FIG. 2, the PC 200 includes a CPU 20, a RAM 21, a ROM 22, an HDD (a storage unit) 23, an LCD (a display unit) 24, and an operating unit 25, and is configured as the same as a general information processing terminal. The LCD (the display unit) 24 and the operating unit 25 are connected to a bus 27 via an interface (I/F) 26.

The central processing unit (CPU) 20 is a calculation unit and controls the operation of a whole of the PC 200. The random access memory (RAM) 21 is a volatile storage medium capable of fast reading and writing of information, and is used as a work area when the CPU 20 performs the processing of information. The read only memory (ROM) 22 is a non-volatile storage medium for read-out only, and stores therein programs such as firmware. The HDD 23 is a non-volatile storage medium capable of reading and writing information, and stores therein an operating system (OS), various control programs and application programs, and others. The LCD 24 is a visual user interface for the user to check the state of the PC 200. The operating unit 25 is a keyboard, a mouse, and others, and is a user interface for the user to input information to the PC 200. The LCD (the display unit) 24 and the operating unit 25 may be formed integrally as an operation panel such as a touch panel, for example.

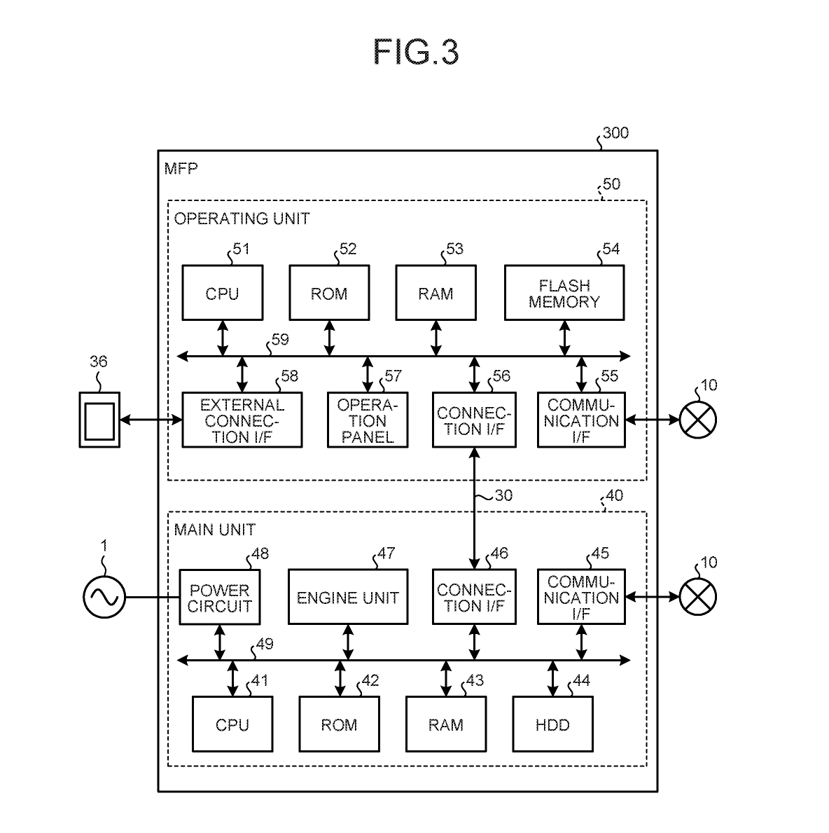

Next, with reference to FIG. 3, the hardware configuration of the image processing apparatus 300 will be described. As illustrated in FIG. 3, the image processing apparatus 300 includes a main unit 40 that is capable of implementing various functions such as a copying function, a scanner function, a facsimile function, and a printer function, and an operating unit 50 that receives the operating input of the user. To receive the operation of the user is a concept that includes the receiving of information inputs corresponding to the operation of the user (including signals representing coordinate values of the screen). The main unit 40 and the operating unit 50 are connected to be able to perform communication with each other via a dedicated communication channel 30. While the communication channel 30 can use one that is of universal serial bus (USB) standard, for example, it may be of any standard regardless of being wired or wireless.

The main unit 40 can perform an operation corresponding to the operation received by the operating unit 50. The main unit 40 is capable of performing communication with an external device such as the PC 200 and can further perform an operation corresponding to instructions received from the external device.

First, the hardware configuration of the main unit 40 will be described. As illustrated in FIG. 3, the main unit 40 includes a CPU 41, a ROM 42, a RAM 43, a hard disk drive (HDD) 44, a communication interface (I/F) 45, a connection I/F 46, and an engine unit 47, and a power circuit 48, and the foregoing are connected to one another via a system bus 49.

The power circuit 48 is electrically connected to a power source 1 (a commercial power supply in this example), and supplies power supplied from the power source 1 to the respective units of the image processing apparatus 300. In FIG. 3, the illustration for electrical supply lines to be connected to the respective units of the image processing apparatus 300 is omitted.

The CPU 41 comprehensively controls the operation of the main unit 40. The CPU 41 controls the operation of a whole of the main unit 40 by executing programs stored in the ROM 42 or the HDD 44 with the RAM 43 as a work area, and implements the foregoing various functions such as the copying function, the scanner function, the facsimile function, and the printer function.

The communication I/F 45 is an interface to connect to the network 10. The connection I/F 46 is an interface to perform communication with the operating unit 50 via the communication channel 30. The CPU 41 controls the connection I/F 46 to communicate with the PC 200.

The engine unit 47 is the hardware that performs the processing, other than the generalized information processing and communication, for implementing the copying function, the scanner function, the facsimile function, and the printer function. For example, the engine unit 47 includes a scanner (an image-reading unit) that scans and reads an image of a document, a plotter (an image forming unit) that performs printing to a sheet member such as paper, and a facsimile unit that performs facsimile communication. The engine unit 47 can further include specific options such as a finisher that sorts the printed sheet members and an automatic document feeder (ADF) that automatically feeds documents.

Next, the hardware configuration of the operating unit 50 will be described. As illustrated in FIG. 3, the operating unit 50 includes a CPU 51, a ROM 52, a RAM 53, a flash memory 54, a communication I/F 55, a connection I/F 56, an operation panel 57, and an external connection I/F 58, and the foregoing are connected to one another via a system bus 59.

The CPU 51 comprehensively controls the operation of the operating unit 50. The CPU 51 controls the operation of a whole of the operating unit 50 by executing a computer program stored in the ROM 52 or the flash memory 54 with the RAM 53 as a work area, and implements various functions, such as display of the information (images) corresponding to the input received from the user, which will be described later. The RAM 53 and the flash memory 54 further function as a storage unit that stores therein history information indicative of operation history of the user received via the remote operation screen that the PC 200 displays or the operation screen that the operation panel 57 displays.

The communication I/F 55 is an interface to connect to the network 10. The connection I/F 56 is an interface to perform communication with the main unit 40 via the communication channel 30.

The operation panel 57 receives a variety of inputs corresponding to the operation of the user and displays a variety of information (for example, the information corresponding to the operation received, the information indicative of an operation status of the image processing apparatus 300, and the information indicative of a setting condition). While the operation panel 57 is configured with a liquid crystal display device (LCD) having a touch panel function in this example, the operation panel 57 is not limited to this. For example, the operation panel 57 may be configured with an organic EL display device having a touch panel function. Moreover, in addition to or in place of this, an operating unit such as hardware keys and a display unit such as lamps can be provided.

The external connection I/F 58 is an interface to connect an IC card reader 36, for example.

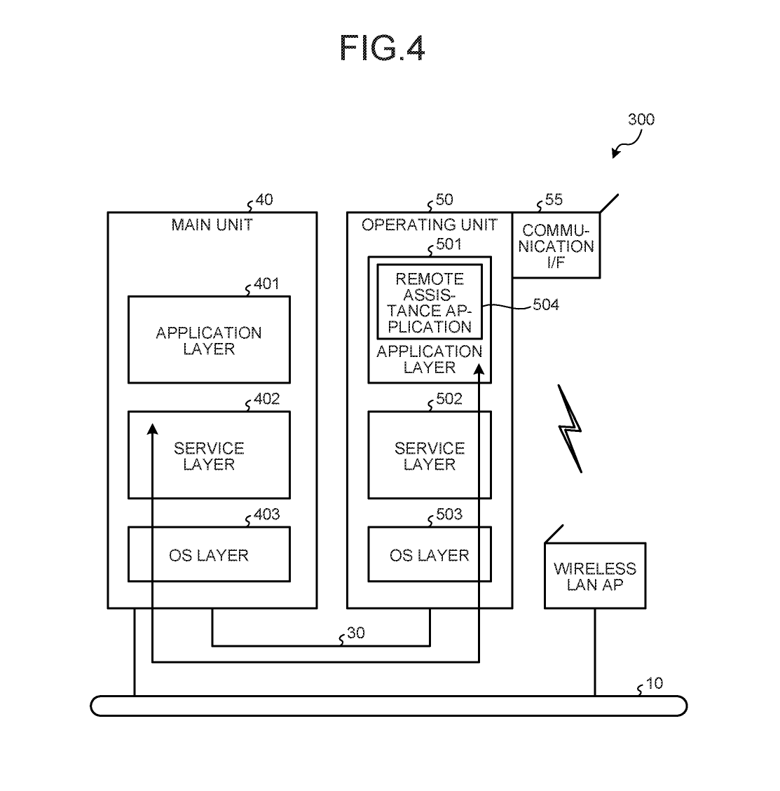

Next, the software configuration of the image processing apparatus 300 will be described. FIG. 4 is a schematic diagram illustrating one example of the software configuration of the image processing apparatus 300. As illustrated in FIG. 4, the main unit 40 has an application layer 401, a service layer 402, and an OS layer 403. The entities of the application layer 401, the service layer 402, and the OS layer 403 are a variety of software stored in the ROM 42 and the HDD 44. These pieces of software are executed by the CPU 41, thereby providing various functions.

The software in the application layer 401 is the application software (hereinafter may simply be referred to as “app”) to operate hardware resources to provide a certain function. As for the app, a copying app to provide a copying function, a scanner app to provide a scanner function, a facsimile app to provide a facsimile function, and a printer app to provide a printer function are included.

The software of the service layer 402 interposes between the application layer 401 and the OS layer 403 and is the software that provides for the app an interface to use the hardware resources that the main unit 40 is provided with. More specifically, the software of the service layer 402 is the software to provide a function of receiving an operation request for the hardware resources and mediating the operation request. As for the operation requests that the service layer 402 receives, a request for reading with the scanner, a request for printing with the plotter, and others are conceivable.

The interface function of the service layer 402 is provided not only for the application layer 401 of the main unit 40 but also for the application layer 501 of the operating unit 50. That is, the application layer 501 (apps) of the operating unit 50 also can implement the functions using the hardware resources (for example, the engine unit 47) of the main unit 40 via the interface function of the service layer 402.

The software of the OS layer 403 is the basic software (an operating system) to provide the basic functions of controlling the hardware that the main unit 40 is provided with. The software of the service layer 402 converts a use request for hardware resources from various apps into commands that are interpretable by the OS layer 403 and delivers them to the OS layer 403. The commands are then executed by the software of the OS layer 403, and thus the hardware resources perform the operation in accordance with the requests of the apps.

Similarly, the operating unit 50 has an application layer 501, a service layer 502, and an OS layer 503. In regard to the hierarchical structure, the application layer 501, the service layer 502, and the OS layer 503, which the operating unit 50 is provided with, are the same as those of the main unit 40 side. However, the functions provided by the apps of the application layer 501 and the type of operation request that the service layer 502 can receive are different from those of the main unit 40 side. The app of the application layer 501 may be the software to provide a certain function by operating the hardware resources that the operating unit 50 is provided with. However, the app of the application layer 501 is mainly the software that provides the function of the user interface (UI) of performing and displaying the operation concerning the functions (the copying function, the scanner function, the facsimile function, the printer function) the main unit 40 provides. A remote assistance app 504 to implement remote assistance is implemented at this application layer 501.

In the present embodiment, to keep the independence of the functions, the software in the OS layer 403 of the main unit 40 side and the software in the OS layer 503 of the operating unit 50 side are different from each other. That is, the main unit 40 and the operating unit 50 operate independently of each other on a separate operating system. For example, as the software in the OS layer 403 of the main unit 40 side, Linux (registered trademark) may be used and, as the software in the OS layer 503 of the operating unit 50 side, Android (registered trademark) may be used.

As in the foregoing, in the image processing apparatus 300 in the embodiment, because the main unit 40 and the operating unit 50 operate on the separate operating systems, the communication between the main unit 40 and the operating unit 50 is performed not as the inter-process communication in a common device but as the communication between different devices. The operation to transmit the information (content of instructions from the user) the operating unit 50 has received to the main unit 40 (command communication) and the operation that the main unit 40 notifies the operating unit 50 of events correspond to this communication. The operating unit 50 here performs command communication to the main unit 40, whereby the functions of the main unit 40 can be used. Examples of the events that the operating unit 50 is notified of from the main unit 40 include the execution status of operation on the main unit 40 and the details of setting defined on the main unit 40 side.

In the embodiment, the power supply for the operating unit 50 is performed from the main unit 40 via the communication channel 30, and the power supply control for the operating unit 50 thus can be performed separately (independently) from the power supply control for the main unit 40.

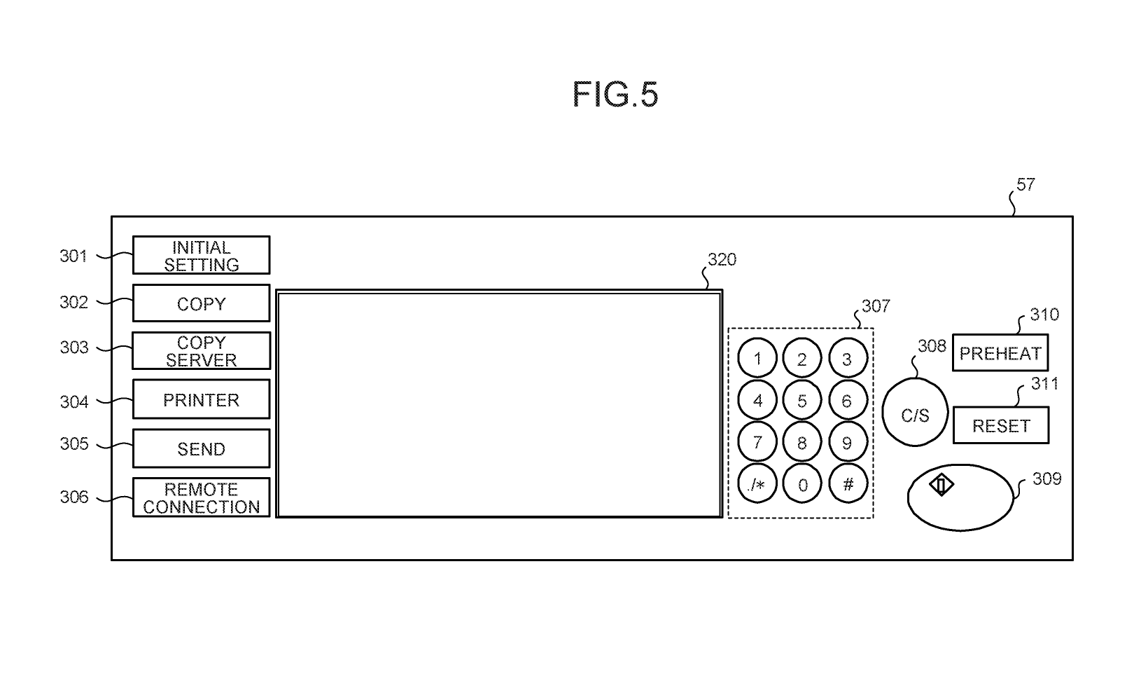

The operation panel 57 of the operating unit 50 receives the operation from the user when the function that the MFP 300 provides is used. FIG. 5 is a diagram illustrating one example of the operation panel 57 of the MFP 300. As illustrated in FIG. 5, such an operation panel 57 includes an initial setting key 301, a copy key 302, a copy server key 303, a printer key 304, a send key 305, a remote connection key 306, a numeric keypad 307, a clear/stop key 308, a start key 309, a preheat key 310, a reset key 311, and a liquid-crystal touch panel 320.

At the remote connection, the same screen as that displayed on the liquid-crystal touch panel 320 of the image processing apparatus (MFP) 300 is displayed on the LCD 24 of the PC 200. The screen displayed on the LCD 24 is referred to as a “remote connection screen”. For example, when the PC 200 requests transmission of the display screen of the MFP 300 at the remote connection, a remote connection screen on the liquid-crystal touch panel 320 is displayed on the LCD 24 of the PC 200. This remote connection screen is also displayed on the display screen of the PC 200.

In this way, on the remote connection screen displayed on the PC 200 or other devices, the support person can refer to the content displayed on the liquid-crystal touch panel 320.

When the screen of the PC 200 is customized, the liquid-crystal touch panel 320 displays the same screen as the customized remote connection screen. The user thus can operate the MFP 300 from the remote connection screen that has been customized to be easy to operate.

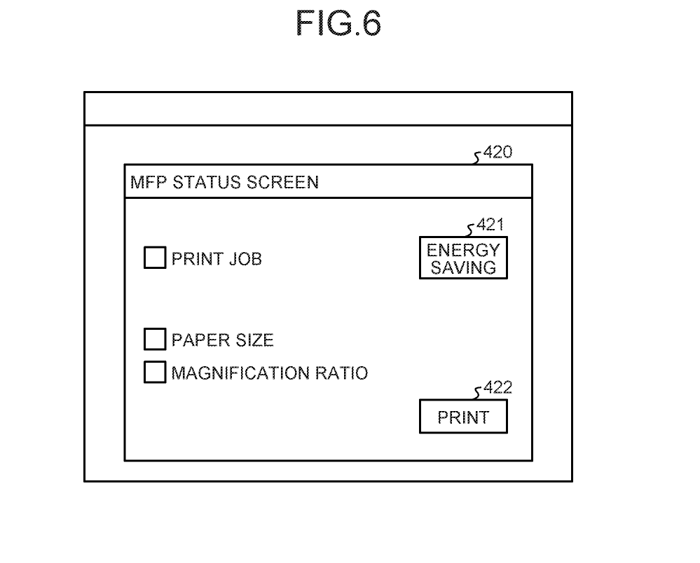

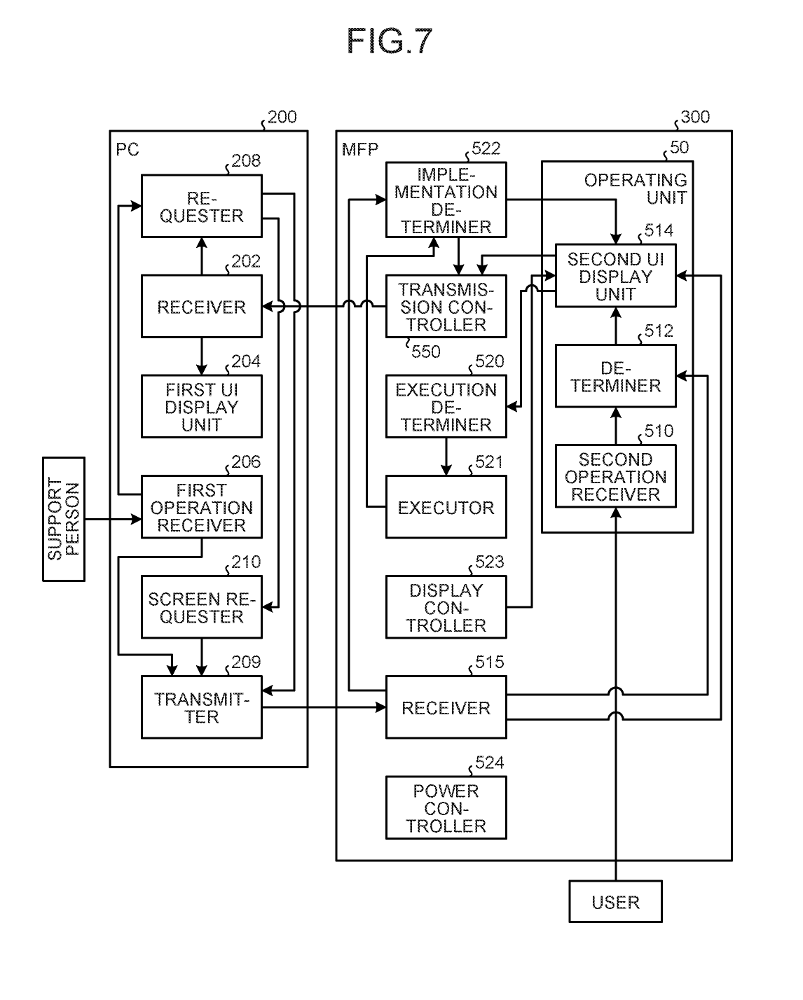

Next, one example of displaying a current status of the image processing apparatus 300 on a remote connection screen will be described with reference to FIG. 7. FIG. 7 illustrates an example of the current status of the image processing apparatus 300 in remote connection. In this screen, the current screen of the image processing apparatus 300 is displayed on the display screen of the PC 200 as an MPF status screen 420 when the PC 200 and the image processing apparatus 300 are remotely connected. As the content of the current status of the image processing apparatus 300, in the MPF status screen 420 illustrated in FIG. 6, for example, displayed are the stand-by status of print job, a paper size, a magnification ratio, an energy-saving display 421 indicative of an energy-saving condition, a print button 422, and others.

Next, the functions that the PC 200 and the image processing apparatus (MFP) 300 include will be described. FIG. 7 is a function block diagram illustrating an outline of the functions that the PC 200 and the image processing apparatus 300 include. The PC 200 includes a receiver 202, a first user interface (UI) display unit 204, a first operation receiver 206, a requester 208, a transmitter 209, and a screen requester 210. The support person is a person who receives inquiries from the user of the image processing apparatus 300 and performs remote operation on the image processing apparatus 300 from the PC 200.

The image processing apparatus 300 includes a receiver 515 that receives a variety of information transmitted from the PC 200. The image processing apparatus 300 also includes a second operation receiver 510, a determiner 512, and a second user interface (UI) display unit, in the operating unit 50. These functions of the operating unit 50 are provided by the remote assistance app 504 illustrated in FIG. 4. The image processing apparatus 300 also include an execution determiner 520, an executor 521, an implementation determiner 522, a display controller 523, a power controller 524, and a transmission controller 550. The user is a person who directly operates the image processing apparatus 300, and makes inquiries to the support person such as when he or she does not understand how to operate the image processing apparatus 300. The transmission controller 550 controls the communication I/F 45 at remote connection to transmit a variety of information as described later to the PC 200.

The receiver 202 receives the variety of information from the image processing apparatus 300 at the remote connection. The variety of information includes screen information, determination information, and operation information described later.

The first UI display unit 204 displays the screen of the PC 200. At remote connection, the first UI display unit 204 causes the LCD 24 to display a screen corresponding to the screen information received at the receiver 202.

The first operation receiver 206 receives the operation (mouse operation and button operation) from the support person using the PC 200. The first operation receiver 206 requests the transmitter 209 to transmit operating information (first operating information) indicative of the operation received from the support person at the remote connection to the image processing apparatus 300. In response to this request, the transmitter 209 transmits the operating information to the image processing apparatus 300. The first operation receiver 206 can also receive the operation that causes the executor 521 to execute the operation.

The implementation determiner 522 of the image processing apparatus 300, when a remote-connection start indicative of permission for remote connection is received in response to the remote-connection start request, determines whether the remote connection can be implemented from the state of the network 10 and the condition of the image processing apparatus 300. The implementation determiner 522 request the transmission controller 550 to transmits the determination result. The transmission controller 550 transmits the determination result to the receiver 202 of the PC 200. The implementation determiner 522 is further configured to hold the information that indicates whether remote connection is currently working.

The requester 208 requests the transmitter 209 to transmit a display screen request for image information to the image processing apparatus 300. In response to this request, the transmitter 209 transmits the display screen request to the image processing apparatus 300. When receiving the screen information for responding to the display screen request, the transmitter 209 displays a screen corresponding to the received display information on the LCD 24 as described above.

The second UI display unit 514 displays a UI screen of the operating unit 50 which includes a print button, an energy-saving button, and others. In response to the screen request, the second UI display unit 514 requests the transmission controller 550 to transmit the screen information currently displayed to the PC 200. When receiving this request, the transmission controller 550 transmits the screen information notified from the second UI display unit 514 to the PC 200. In this way, the transmission controller 550 cause the PC 200 to display the screen displayed on the image processing apparatus 300 at remote connection, receives the screen information from the second UI display unit514, and transmits the screen information to the receiver 202 of the PC 200.

The PC 200 receives the requested screen information at the receiver 202. The PC 200 displays a screen based on the received screen information on the first UI display unit 204.

When the energy-saving button displayed on the UI screen is depressed, the second UI display unit 514 further requests the execution determining unit 520 to determine whether the execution permission to permit the execution of switching to an energy-saving mode (operation) is present (determination request: input execution).

The display controller 523, when it is determined that execution permission to execute is not present, causes the second UI display unit 514 to display that it is not possible to perform the operation processing associated with the operating information.

The second operation receiver 510 receives the operation (such as a touch operation) from the user of the image processing apparatus 300 and notifies the determiner 512 of the operating information (second operating information) indicative of the content of the received operation. The second operation receiver 510 can also receive the operation that causes the executor 521 to execute the operation processing.

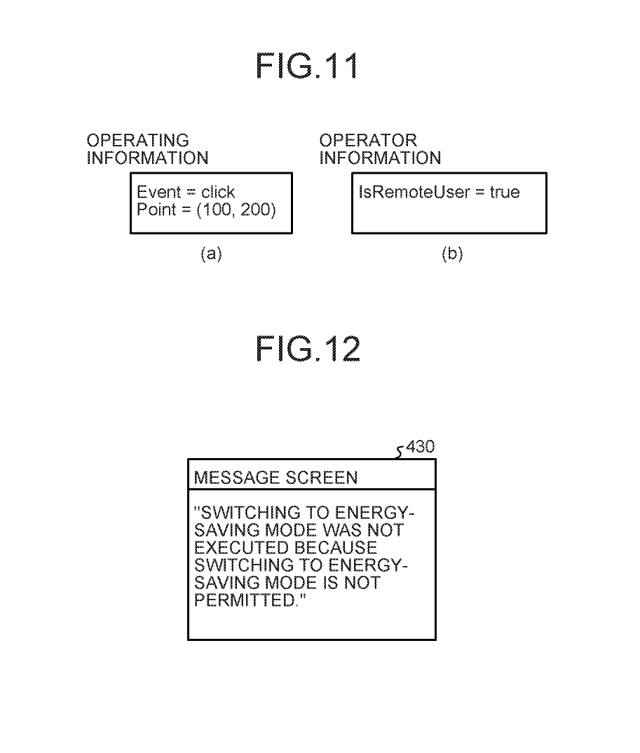

The determiner 512 first determines whether the information is the operating information received by the first operation receiver 206 or the operating information received by the second operation receiver 510. The determiner 512 then adds, using as the operator information the determination result identifying either the user or the support person, the operator information (see FIG. 11) to the operating information, and notifies the second UI display unit 514.

With this operator information added to the operating information, determination is possible, when a job (operation) is executed by the image processing apparatus 300, about whether the execution permission for the operation is present. Furthermore, with the operator information that has been added, determination is possible, when a print job is executed, about whether the job should be charged to the user.

A normal mode and the energy-saving mode is now described. The image processing apparatus 300 operates in accordance with one of the two modes, the normal mode and the energy-saving mode in which power consumption is different. When the image processing apparatus 300 operates in the normal mode, power is supplied to the respective units of the image processing apparatus 300 to enable image forming process. In the energy-saving mode, at least part of the image processing apparatus 300 is suspended, thereby resulting in the power consumption less than in the normal mode. In the specification, the energy-saving is sometimes referred to energy save.

The execution determiner 520 receives a determination request (input execution) from the second UI display unit 514 together with the operator information, and determines whether the execution permission that permits the execution of the operation processing for which the determination request has been received is present. The execution determiner 520 uses, as the criteria to determine whether the execution permission is present, the operator information (user or support person) and authority information (see Table 1).

The executing unit 521, when the execution permission is present, executes the operation of switching to the energy-saving mode, the operation of executing printing, and others, in accordance with the operating information received from the user and the supporter (the remote user). In addition, the executor 521, when the execution determiner 520 permits switching to the energy-saving mode, set the mode from the normal mode to the energy-saving mode, and requests the power controller 524 to switch the power supply from the normal mode to the energy-saving mode. The power controller 524 controls the power circuit 48 to supply power corresponding to the energy-saving mode to the respective units of the image processing apparatus 300.

While these functions of the various units in the image processing apparatus 300 are implemented by the CPU (or the CPU 51) executing the programs stored in a storage device (for example, the ROM 42, the HDD 44, the ROM 52, the flash memory 54), the embodiment is not limited thereto. For example, of the functions of the various units of the image processing apparatus 300, at least a part thereof may be implemented by a dedicated hardware circuit (for example, a semiconductor integrated circuit). The recording of the above-described data may be implemented by the HDD 44 and others of the main unit 40 side, and may be implemented by the flash memory 54 and others of the operating unit 50 side.

In the foregoing embodiment, the main unit 40 and the operating unit 50 operate on the separate operating systems independently of each other. However, the embodiment is not limited thereto, and may be in a form in which the main unit 40 and the operating unit 50 operate on the same operating system.

The programs executed by the image processing apparatus 300 in the above-described embodiment may be configured to be provided in a file of an installable format or an executable format recorded on a computer-readable recording medium such as a CD-ROM, a flexible disk (FD), a CD-R, a digital versatile disk (DVD), and a universal serial bus (USB), and may be configured to be provided or distributed via a network such as the Internet. The various programs may be configured to be provided in a manner embedded in a non-volatile storage medium such as a ROM in advance.

The system configuration of the image processing system 100 illustrated in the embodiment in which the PC 200 and the image processing apparatus 300 are connected is merely one example, and naturally, there may be various system configurations depending on the application and purpose. For example, the image processing apparatus 300 may include the function of the first operation receiver 206.

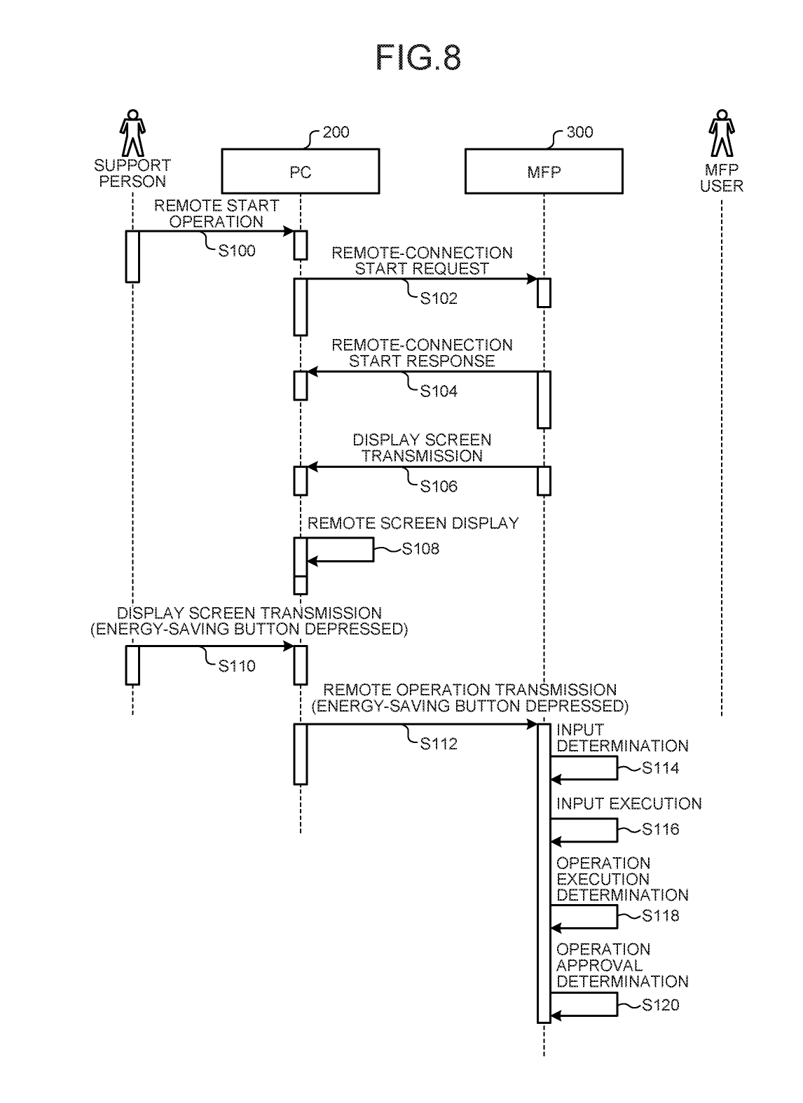

Next, the operation of the image processing system 100 will be described in detail. FIG. 8 is a sequence diagram illustrating the operation of the image processing system 100 when the support person depressed the energy-saving button in remote operation.

First, the support person performs a remote start operation on the PC 200 to start remote control (remote operation) (S100).

When receiving the remote start operation by the support person (S100), the requester 208 transmits a request for the remote-connection start (S102) to the image processing apparatus 300. The image processing apparatus 300 starts up the remote assistance app 504 in response to the request for the remote-connection request.

Subsequently, the image processing apparatus 300 determines whether the remote connection can be implemented from the state of the network 10 and others, and transmits a remote-connection start response indicative of the determination result to the PC 200 (S104). Here, as an example, the PC 200 receives the remote-connection start response indicative of permission for the remote connection from the image processing apparatus 300.

The PC 200 transmits the display screen request described above to the image processing apparatus 300 (S105). The image processing apparatus 300 transmits screen information indicative of a screen currently displayed on the image processing apparatus 300 in response to the display screen request (S106).

The PC 200 displays a screen corresponding to the screen information received from the image processing apparatus 300 as a remote connection screen on the LCD 24 (S108). Accordingly, the same screen as that displayed on the liquid-crystal touch panel 320 of the image processing apparatus 300 is displayed on the LCD 24 of the PC 200.

An example of depressing the energy-saving button is now described. The support person clicks a portion of the energy-saving button while manipulating on the remote screen displayed on the first UI display unit 204 (here, the supporter erroneously depresses the energy-saving button: S110). The first operation receiver 206 of the PC 200 then receives the operating information indicating the operation of clicking the energy-saving button.

Subsequently, the first operation receiver 206 notifies the determiner 512 of the image processing apparatus 300 of the operating information from the PC 200 (remote operation transmission: S112).

The determiner 512 determines whether the operation is the one that the first operation receiver 206 has received or the one that the second operation receiver 510 has received. Here, because the operation is the click operation from the PC 200, the determiner 512 adds the information indicative of the operating input that the remote operating support person has operated (the operator information) to the operating information indicative of the operation that the first operation receiver 206 has received (the click operation information) and transmits the information obtained by the addition to the second UI display unit 514 (S114).

The second UI display unit 514 detects that the energy-saving button has been depressed based on the operating information (click operation information), and requests the execution determiner 520 to determine whether the execution permission to permit the execution of switching to an energy-saving mode (operation) is present (input execution: S116). At this time, the second UI display unit 514 further transmits to the execution determiner 520 the operator information that has been added by the determiner 512.

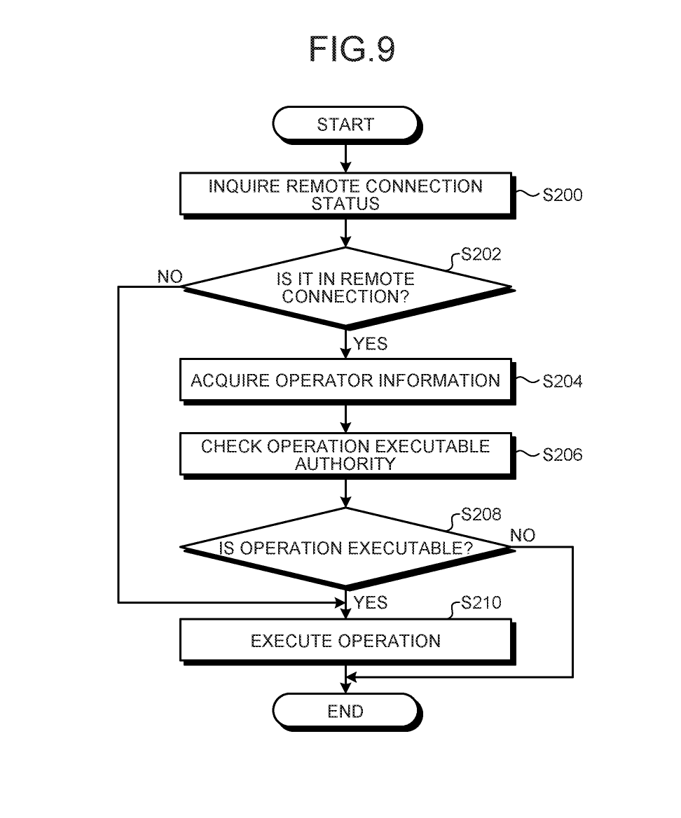

When the determination request (input execution) is received from the second UI display unit 514 together with the operator information, the execution determiner 520 determines whether the execution permission that permits the execution of the operation processing for which the determination request has been received is present. That is, when the determination request to determine whether the execution permission of switching to the energy-saving mode is present is received, the execution determiner 520 determines whether the mode can be switched to the energy-saving mode (operation execution determination: S118). The determining method here will be described with reference to FIG. 9. The execution determiner 520 determines here that switching to the energy-saving mode is disapproved (no execution permission), by using a later-described Table 1.

The execution determiner 520 notifies the executor 521 of the information indicating the result of determining whether the execution permission of switching to the energy-saving mode is present. Because the execution determiner 520 here determines that switching to the energy-saving mode is disapproved (no execution permission), the executor 521 ends the processing without executing any operation (operation approval determination: S120). Meanwhile, when the execution determiner 520 determines that the execution permission of the operation processing is present, the executor 521 is to execute the operation.

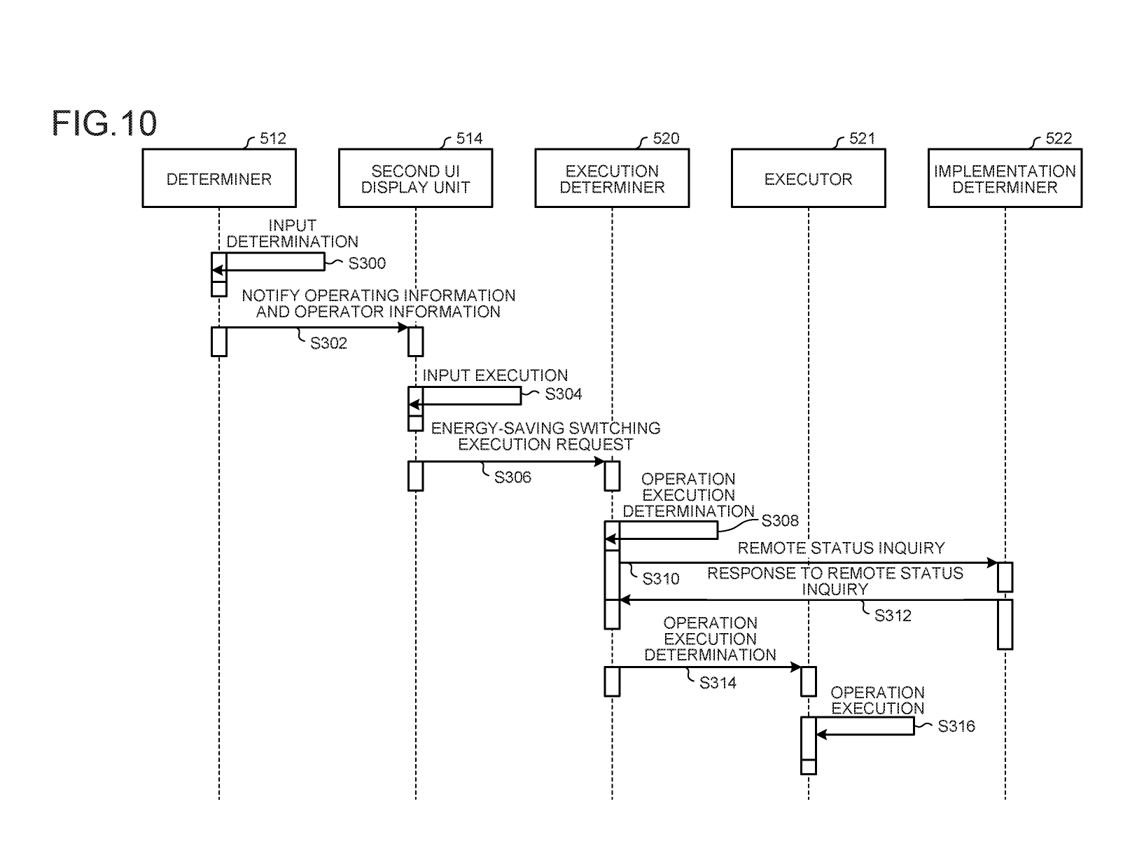

As for the processing at S114 to S120 illustrated in FIG. 8, the operation of the various units constituting the image processing apparatus 300 is also illustrated in FIG. 10.

FIG. 9 is a flowchart illustrating in detail the processing that the execution determiner 520 determines whether execution permission of operation processing is present. Exemplified here is a situation in which the execution determiner 520 determines about switching to the energy-saving mode illustrated in FIG. 8.

When a determination request to determine whether the execution permission of switching to the energy-saving mode is present is received from the second UI display unit 514, the execution determiner 520 first inquires the implementation determiner 522 of whether remote connection is currently working (S200).

Then, when remote connection is not working (No at S202), the execution determiner 520 advances to the processing of S210 to cause the executor 521 to execute the operation of switching to the energy-saving mode as normal. Meanwhile, when remote connection is working (Yes at S202), the execution determiner 520 advances to the processing of S204.

When remote connection is working, the execution determiner 520 acquires the operator information indicative of the operator who has performed the request operation of switching to the energy-saving mode (S204). That is, the execution determiner 520 checks which of the first operation receiver 206 or the second operation receiver 510 has received the operating information.

The execution determiner 520 then checks which of the user or the support person has operation executable authority (the authority information) for the operation of switching to the energy-saving mode (energy-saving execution) in remote connection by using Table 1 (S206). Table 1 is an information table indicating an example of data structure of operation executable authority (the authority information). Table 1 is used to determine, in remote connection, the operation that the user can cause the image processing apparatus 300 to execute and the operation that the support person can cause the image processing apparatus 300 to execute. That is, Table 1 is the authority information that defines in advance on which of a plurality of operations the support person and the user have authority to cause the executor 521 to execute. As just described, in Table 1, the support person is given minimum execution authority to perform remote connection to the image processing apparatus 300 and obtain information for diagnosing the apparatus and instructing operation procedures.

TABLE 1

authority

| processing to be executed | User | Support person |
|---|---|---|
| Energy-saving execution | Disapproved | Disapproved |
| Power off | Disapproved | Disapproved |
| Copying | Approved | Disapproved |
| Scanner use | Approved | Disapproved |
| Fax use | Approved | Disapproved |
| User information display | Approved | Disapproved |
| Address book display | Approved | Disapproved |
| Debug mode display | Disapproved | Approved |
| Web browser display | Approved | Approved |
| . . . | . . . | . . . |

In this Table 1, execution permission of processings corresponding to combinations of the user and a plurality of operation processings and combinations of the support person and the operations processings is illustrated, as authority information. In other words, the authority information indicates that execution of processings that involve charging is not permitted with respect to the combinations of the first user (the support person) and the processings that involve charging. Here, the operation processing that involve charging is for any one of copying processing, facsimile processing, and scanner; processing. The authority information indicates that execution of the operation processings that cannot continue remote operation is not permitted.

In Table 1, more specifically, the authority information is set that the user and the support person are disapproved of remote operation when the image processing apparatus 300 is in energy-saving mode and shutdown due to power OFF (power switch, not illustrated, is turned OFF). In Table 1, when the operation processing indicates execution of the energy-saving more for the image processing apparatus 300 or shutdown of the image processing apparatus 300, it is determined that the execution of the corresponding operation processing is not permitted. In other words, the image processing apparatus 300 controls power to be supplied to a predetermined unit constituting the image processing apparatus 300 to do shutdown or switch to low power in order to reduce power consumption. In the energy-saving mode and the power OFF (shutdown), to disconnect remote connection for energy saving. With this, in the image processing system 100, remote connection is disconnected when the operation of switching to the energy-saving mode (energy-saving execution) is executed in the remote connection. It is thus defined that neither the user nor the support person can execute the switching to the energy-saving mode, as listed in Table 1. In the same manner, the operation of power off makes it possible to prevent the remote connection from being disconnected during remote support.

In Table 1, processings concerning copying, facsimile (FAX), and scanner are each set as the operation processing for charging. In Table 1, regarding the copying operation for example, it is defined that the user is approved while the support person is disapproved. This is because a problem arises in which, when the support person erroneously executes a copying operation, the user is charged therefor. Accordingly, scanner use, facsimile use and scanner use due to erroneous operation of the support person are not permitted, and thus the user is prevented from being erroneously charged.

The example listed in Table 1 further makes it possible to restrict the display of information undesirable to be seen by the support person such as user information display and address book display (personal information and confidential information), and also makes it possible for the user to receive support via remote operation with a sense of security. In Table 1, in addition to the foregoing, the item that is displayable only by the support person such as a debug mode and the item that is executable by both the user and the support person such as web browser display are also included.

The execution determiner 520 determines, depending on the combination of the operator information acquired in the processing of S204 and the operation executable authority (the authority information) checked in the processing of S206, whether the execution permission for the received operating information is present. That is, the execution determiner 520 determines whether the operation of switching to the energy-saving mode is executable (S208).

When it is determined that the execution permission is present (Yes at S208), the execution determiner 520 advances to the processing of S210. When it is determined that the execution permission is not present (No at S208), the execution determiner 520 ends the processing.

Because the operator information indicates the support person and the support person does not have the operation executable authority for the operation of switching to the energy-saving mode (permitted by nobody) here, the operation of switching to the energy-saving mode is not executed and the processing is ended. FIG. 12 illustrates an example of a message screen when the determination result is non-executable. In this case, as illustrated in FIG. 12, a message such as “switching to energy-saving mode was not executed because the permission of switching to energy-saving mode is not present” is displayed on the display screen of the PC 200.

When the operation processing is for any one of copying, facsimile, and scanner, the execution determiner 520 determines that the operation processing involves charging. In the case of executing the operation that involves printing such as copying or facsimile and scanner use, it is defined that only the user has the operation executable authority of executing any one of copying, facsimile, and scanner because a problem arises in which, when the support person executes printing such as copying or facsimile and scanner use, the user is charged therefor. That is, the operation of any one of copying, facsimile, and scanner is not executed even when the support person requests the execution of the operation of any one of copying, facsimile, and scanner, but the operation of copying or facsimile is executed when the user requests the execution of the operation of any one of copying, facsimile, and scanner.

As just described, in the processing of S208, when the execution determiner 520 determines that the execution permission is present, the executor 521 executes the operation corresponding to the operating information (S210).

FIG. 10 is a sequence diagram illustrating the operation performed by the various units constituting the image processing apparatus 300 when the support person depressed the energy-saving button in remote connection.

The determiner 512 determines whether the received operating information is the operating information received by the first operation receiver 206 or is the operating information received by the second operation receiver 510 (S300). The determiner 512 further delivers the operating information and the operator information to the transmitter 209 to transmit these information from the transmitter 209 to the receiver 55 via the network. The operating information and the operator information received at the receiver 515 are notified to the second UI display unit 514 (S302).

FIG. 11 is a diagram illustrating data structure of the operating information and the operator information. The operating information illustrated in FIG. 11(a) is the value indicating what kind of operation the support person and the user have performed. This illustrates the information indicating that a portion of the screen with an x coordinate of 100 and a y coordinate of 200 was clicked. The operator information illustrated in FIG. 11(b) is the information that the determiner 512 adds to the operating information and indicates whether the notified operating information is the one from the support person or the one from the user. This illustrates that this operating information has been notified from the support person.

The second UI display unit 514 detects that the energy-saving button has been depressed based on the operating information, and requests the execution determiner 520 to determine whether the execution permission to permit the execution of switching to the energy-saving mode (operation) is present (input execution: S304).

When the request of determining whether the execution permission to execute switching to the energy-saving mode is present (an energy-saving switching execution request) is received from the second UI display unit 514 together with the operator information (S306), the execution determiner 520 determines whether the execution permission that permits the execution of the operation for which the determination request has been received is present (operation execution determination: S308).

The execution determiner 520 inquires the implementation determiner 522 of the state of remote connection (S310), and obtains from the implementation determiner 522 the response to the inquiry (S312).

The execution determiner 520 notifies the executor 521 of the information indicating the result of determining whether the execution permission of switching to the energy-saving mode is present (operation execution determination) (S314). Because the execution determiner 520 here determines that switching to the energy-saving mode is disapproved (no execution permission), the executor 521 ends the processing without executing any operation. Meanwhile, when the execution determiner 520 determines that the execution permission of the operation is present, the executor 521 is to execute the operation (operation execution: S316).

As in the foregoing, the image processing system 100 distinguishes, in a condition that the support person is performing a remote operation on the screen of the image processing apparatus 300 from the PC 200 to perform remote support to the user, the input from the user to the image processing apparatus 300 and the input to the PC 200 of the support person (remote operation). That is, with the operator restricting authority of the execution of switching to the energy-saving mode and the execution of operation that involves printing such as copying, the image processing system 100 can prevent an inappropriate operation (erroneous operation) in remote support.

According to the embodiments described above, an inappropriate operation processing by remote support can be prevented from being executed on the image processing apparatus.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing system comprising:
a remote operation terminal; and
an information processing apparatus configured to be remotely operated by the remote operation terminal via a network,
the remote operation terminal including
a first operation receiver configured to receive first operating information of a first user who operates the information processing apparatus, and
a transmitter configured to transmit the first operating information indicative of an operation received by the first operation receiver to the information processing apparatus,
the information processing apparatus including
a receiver configured to receive the first operating information transmitted from the transmitter,
a second operation receiver configured to receive second operating information of a second user who operates the information processing apparatus,
an execution determiner configured to determine, for each of combinations of the first user and a plurality of operation processings and combinations of the second user and the plurality of operation processings, whether the operation processing corresponding to the first operating information or the operation processing corresponding to the second operating information can be executed, based on authority information indicative of execution permission of the operation processing of the corresponding combination, and
an executor configured to execute the operation processing determined to have execution permission by the execution determiner.

2. The information processing system according to claim 1, wherein the authority information indicates that execution of processing that involves charging is not permitted for a combination of the first user and the processing that involves charging.

3. The information processing system according to claim 2, wherein the processing that involves charging is any one of copying processing, facsimile processing, and scanner processing.

4. The information processing system according to claim 1, wherein the authority information indicates that execution of operation processing that cannot continue remote operation is not permitted for the operation processing.

5. The information processing system according to claim 1, wherein the authority information indicates that execution of operation processing of energy-saving mode of the information processing apparatus or shutdown of the information processing apparatus is not permitted for the operation processing.

6. The information processing system according to claim 1, wherein the image processing apparatus includes
a display unit, and
a display controller configured to, when operation processing is determined to have no execution permission to be executed by the execution determiner, cause the display unit to display that the operation processing cannot be executed.

7. The image processing system according to claim 1, further comprising a determiner configured to determine, based on the first operating information or the second operating information, whether the operation processing is caused due to the first user or the second user, and add a determination result that identifies the first user or the second user, as operator information, to the first operating information or the second operating information.

8. The image processing system according to claim 7, wherein the execution determiner of the information processing apparatus determines whether the operation processing corresponding to the first operating information received by the first operation receiver or the operation processing corresponding to the second operating information received by the second operation receiver can be executed, based on the authority information and the operator information added to the first operating information or the second operating information.

9. An image processing method comprising:
receiving first operating information of a first user who operates an information processing apparatus connected to a network;
receiving second operating information of a second user who operates the information processing apparatus;
determining, for each of combinations of the first user and a plurality of operation processings and combinations of the second user and the plurality of operation processings, whether the operation processing corresponding to the first operating information or the operation processing corresponding to the second operating information can be executed, based on authority information indicative of execution permission of the operation processing of the corresponding combination; and
executing the operation processing determined to have execution permission at the determining.

10. An information processing apparatus configured to be remotely operated by a remote operation terminal via a network, the information processing apparatus comprising:
a receiver configured to receive first operating information of a first user who operates the information processing apparatus from the remote operation terminal;
a second operation receiver configured to receive second operating information of a second user who operates the information processing apparatus;
an execution determiner configured to determine, for each of combinations of the first user and a plurality of operation processings and combinations of the second user and the plurality of operation processings, whether the operation processing corresponding to the first operating information or the operation processing corresponding to the second operating information can be executed, based on authority information indicative of execution permission of the operation processing of the corresponding combination; and
an executor configured to execute the operation processing determined to have execution permission by the execution determiner.
